(19) United States
(12) Patent Application Publication
(10) Pub. No.: US 2007/0068754 A1
(43) Pub. Date: Mar. 29, 2007

(54) GAS-BIASED HYDRAULIC CYLINDER

(76) Inventor: GEORGE WOJCIECH FURGALA, Surrey (CA)

Correspondence Address: NEXUS LAW GROUP LLP, 1500 - 701 WEST GEORGIA STREET, VANCOUVER, BC, V74-1C6, CA

(21) Appl. No.: 11/162,840

(22) Filed: Sep. 26, 2005

(51) Int. Cl. F16F 9/43

(52) U.S. Cl. 188/322.21; 188/315; 267/64.28

(57) ABSTRACT

A gas-biased hydraulic cylinder for compensating for the tare weight of a material handling apparatus to be actuated by the cylinder. A tubular body is capped by a cylinder head and a blind end. A piston assembly comprising a hollow cylinder rod having a piston travels through the cylinder head, the piston being seated within the tubular body for reciprocating action therein. The piston is actuated by hydraulic fluid. A hollow cylinder projects from the blind end through an opening in the piston assembly and into the hollow cylinder rod, the hollow cylinder and the piston assembly being sealingly and slidably connected. The interiors of the hollow cylinder and hollow cylinder rod form an interior chamber that is pressurized with gas to bias the cylinder rod so as to compensate for the tare weight of the material handling apparatus.

### FIELD OF THE INVENTION

The present invention relates to hydraulic cylinders and in particular to a hydraulic cylinder biased by a pressurized gas within the hydraulic cylinder.

### BACKGROUND OF THE INVENTION

Hydraulic cylinders are used as actuators in a wide variety of applications, particularly in association with heavy construction equipment. A simple hydraulic cylinder comprises a cylinder tube body having blind (rear) and rod (front) ends and a cylindrical bore travelling from the rear to the front end defining a piston chamber. The blind and rod ends each have inlet-outlet ports for selectively feeding and discharging hydraulic fluid into the bore. A rod having an actuation end and a piston end is slidingly and sealingly mounted in an opening in the rod end and extends into the cylinder tube body through the opening. The piston end is slidably and sealingly mounted in the cylindrical bore. The selective feeding and discharging of hydraulic fluid into the bore on either side of the piston forces the piston (and rod) to move along the longitudinal axis of the piston chamber.

More specialized hydraulic cylinders have been designed for various uses. For example, U.S. Pat. No. 3,869,861 teaches a combination hydraulic cylinder and accumulator providing floating support. The hydraulic cylinder has a pair of pistons separated by a pressurized gas chamber. One of the pistons is free floating within the cylinder, while the second is extensible and is adapted for connection to the object to be controlled. The second piston has a longitudinal passage, which is sealed by a plug at an exterior end and which opens into the gas chamber at the other end. By removing the plug, one can then charge the gas chamber to a desired gas pressure, preferably using nitrogen gas. While the pressurized gas chamber does function as an accumulator in floatingly supporting the second piston, it does not act to compensate for the tare weight of the apparatus connected to the second piston (or the second piston itself), as hydraulic fluid is used to actuate the first piston, the second piston and whatever is attached to the second piston.

For those applications where a hydraulic cylinder is going to be used for repetitive lifting, it is beneficial to have a cylinder that is biased to compensate for the tare weight of the apparatus doing the lifting. A number of accumulators have been designed to compensate for the tare weight.

U.S. Pat. No. 3,971,215 teaches a power shovel equipped with a piston and cylinder assembly having an energy storing system. The hydraulic cylinder has a fixed piston connected at the blind end. A movable piston is mounted on the fixed piston within the cylinder. Both the fixed and the movable pistons are hollow. Hydraulic fluid is used to actuate the movable piston. The cylinder is fluidly connected to a hydropneumatic accumulator which acts to bias the movable piston (and component attached thereto) toward a predetermined movement. While providing a biasing force to extend the cylinders, the accumulator is charged by the machine energy when the cylinders are being retracted.

U.S. Pat. No. 4,738,101 also teaches an energy storage system for a hydraulic cylinder. A piston and cylinder assembly is actuated using hydraulic fluid only. The hydraulic cylinder is connected to an external accumulator which provides fluid under pressure to the piston/cylinder assembly in order to counterbalance the unit being supported.

While providing useful energy storage systems, the '215 and '101 systems nevertheless suffer from being complicated, requiring a series of directional valves, relief valves, accumulators and the like.

There is therefore a continuing need for an improved hydraulic cylinder biased to compensate for the tare weight of the apparatus to be moved by the cylinder so as to decrease the required energy to do the work.

### SUMMARY OF THE INVENTION

The present invention comprises a hydraulic cylinder biased by pressurized gas within the cylinder assembly. The cylinder has two chambers adapted to be filled with or emptied of hydraulic fluid when selectively communicated by a hydraulic system. The hydraulic fluid is used to actuate a piston and extend or retract the cylinder to a selectively communicated position. A third chamber within the cylinder is filled with a pressurized gas which creates a force to bias the piston a pre-set amount.

According to a preferred embodiment of the invention there is provided a gas-biased hydraulic cylinder for compensating for the tare weight of a lifting assembly of a material handling apparatus to be actuated. The hydraulic cylinder has a tubular body having first and second ends and defining a chamber and a piston assembly comprising a cylinder rod having a piston at a piston end. The cylinder rod is hollow and passes through an opening located in the first end of the tubular body. The piston is sealingly and slidably mounted within the chamber and an opposite end of the cylinder rod is located outside of the tubular body. The hydraulic cylinder also has a hollow cylinder projecting from the second end of the tubular body in the chamber and into the piston assembly through an opening disposed in the piston end. The hollow cylinder and the piston assembly are sealingly and slidably connected. The piston is selectively actuatable by hydraulic fluid for reciprocating action in the chamber to move the cylinder rod back and forth through the opening in the first end of the tubular body and along the hollow cylinder. The interiors of the hollow cylinder and of the cylinder rod form an interior chamber. The interior chamber is filled with pressurized gas to bias the cylinder rod a pre-set amount to compensate for the tare weight of the lifting assembly of the material handling apparatus.

In another aspect, the hydraulic cylinder is equipped with a charge valve for filling the interior chamber with pressurized gas

In another aspect, the hollow cylinder is fluidly connected to an external expansion tank providing an increased volume of pressurized gas.

According to an alternative embodiment of the invention there is provided a gas-biased hydraulic cylinder for compensating for the tare weight of a lifting assembly to be actuated. The hydraulic cylinder comprises a tubular body having an open end and a closed end, a hollow cylinder extending from the closed end within the tubular body, a hollow cylinder rod sealingly and slidably mounted in the open end having an actuation end outside of the tubular body and a piston end inside the tubular body, a piston connected to the piston end and sealingly and slidably mounted within the tubular body, the piston actuatable by hydraulic fluid for reciprocating action within the tubular body, the hollow cylinder and hollow cylinder rod matingly connected to form an interior chamber filled with pressurized gas to bias the cylinder a pre-set amount.

The foregoing was intended as a broad summary only and of only some of the aspects of the invention. It was not intended to define the limits or requirements of the invention. Other aspects of the invention will be appreciated by reference to the detailed description of the preferred embodiment and to the claims.

### BRIEF DESCRIPTION OF THE DRAWINGS

These and other features of the invention will become more apparent from the following description in which reference is made to the appended drawings and wherein:

FIG. 1 is a cross-sectional view of the preferred embodiment of a hydraulic cylinder according to the invention;

FIG. 1a is a partial cross-sectional view of the cylinder shown in FIG. 1;

FIG. 1b is a partial cross-sectional view of a hydraulic cylinder having an alternative sealing arrangement;

FIG. 1c is a partial cross-sectional view of a hydraulic cylinder having a further alternative sealing arrangement;

FIG. 2 is a cross-sectional view of an alternative embodiment of a hydraulic cylinder according to the invention;

FIG. 2a is a partial cross-sectional view of the cylinder shown in FIG. 2;

FIG. 3 is a cross-sectional view of a further alternative embodiment of a hydraulic cylinder according to the invention;

FIG. 4 is a cross-sectional view of a further alternative embodiment of a hydraulic cylinder according to the invention;

FIG. 5 is a side view of a hydraulic excavator with a material handling front equipped with hydraulic cylinders according to the invention;

FIG. 6 is a side view of a hydraulic excavator with a bucket equipped with a hydraulic cylinder according to the invention;

FIG. 7 is a side view of a hydraulic front shovel and a bucket equipped with a hydraulic cylinders according to the invention; and

FIG. 8 is a side view of a Wheel Loader and a bucket equipped with hydraulic cylinders according to the invention.

### DETAILED DESCRIPTION OF THE PREFERRED EMBODIMENTS

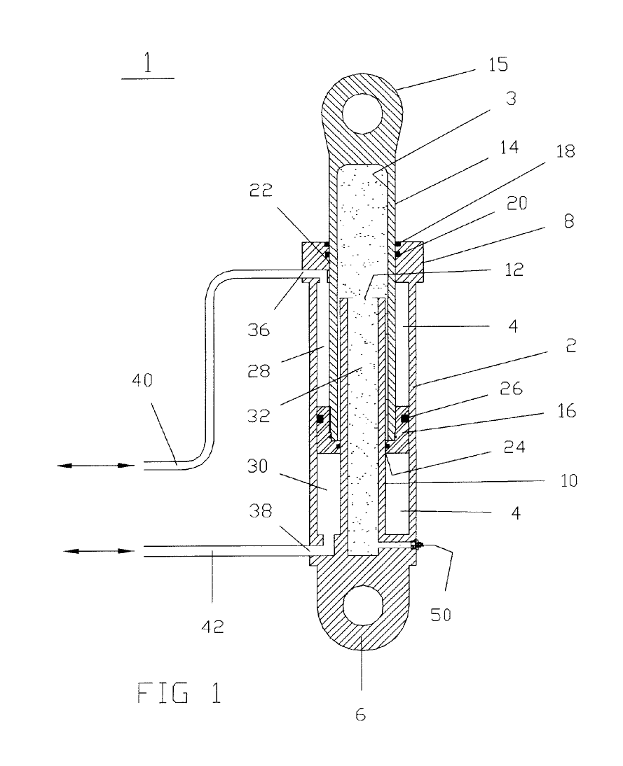

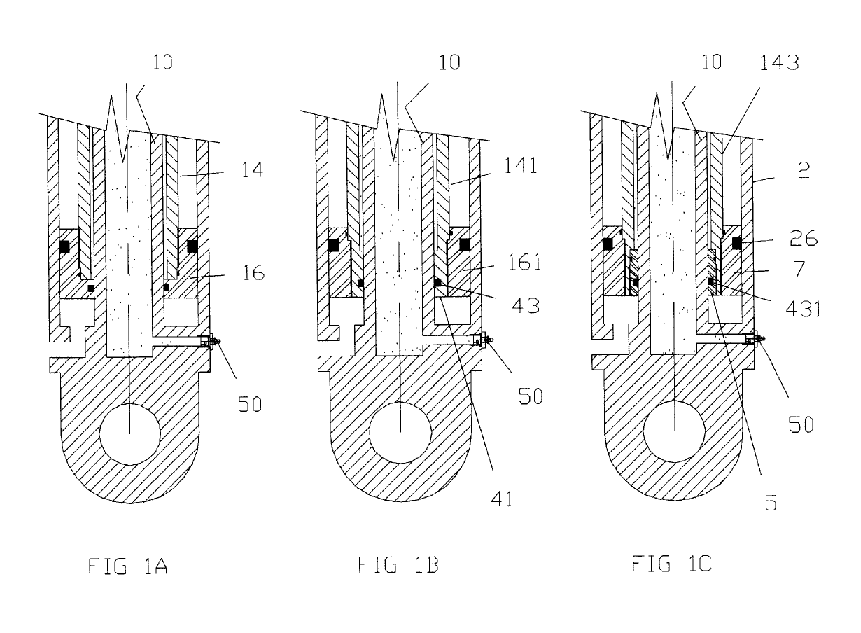

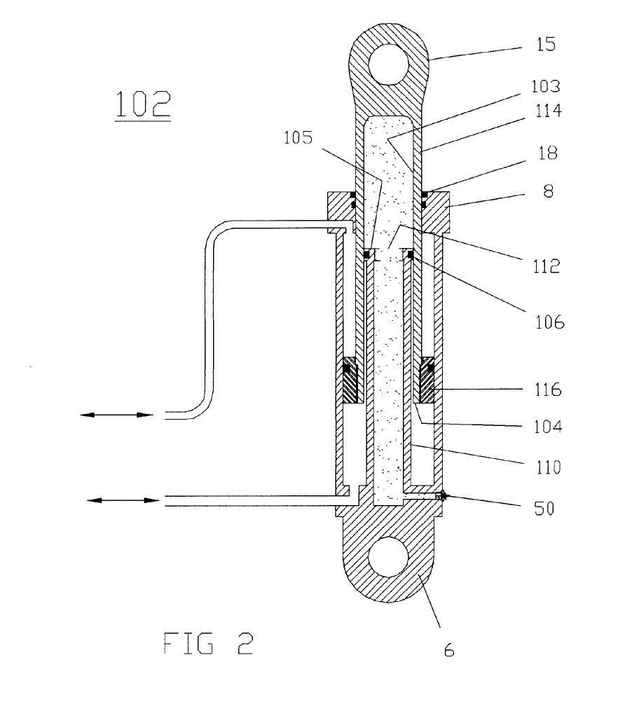

The preferred embodiment of a gas-biased hydraulic cylinder according to the invention generally referred to as reference numeral 1 is shown in FIG. 1. Referring to FIG. 1, it can be seen that the hydraulic cylinder 1 generally comprises a tubular body 2 defining a longitudinally disposed cylindrical chamber 4 bounded by a blind end 6 and a rod end cylinder head 8 as known in the art.

The rod end cylinder head 8 preferably has a wiper 18 and a seal 20 or any suitable sealing system known in the art. A longitudinally disposed cylindrical opening 22 passing through cylinder head 8 is substantially aligned with the longitudinally disposed cylindrical chamber 4. The blind end 6 is adapted to be connected to a fixed or movable object.

A reciprocable hollow cylinder rod 14 has a piston 16 mounted at a piston end and a connection end 15 at the other. The combination of the hollow cylinder rod 14 and piston 16 will be referred to hereafter as a piston assembly. Connection end 15 is adapted to be connected to a fixed or movable object. The hollow cylinder rod 14 is sized to correspond to the diameter of the cylindrical opening 22 and is adapted to be slidingly and sealingly seated therein for reciprocating action therethrough.

A hollow cylinder 10 projects from blind end 6 into cylindrical chamber 4, terminating in an open end 12. Hollow cylinder 10 is sized to fit within the interior of the hollow cylinder rod 14. Hollow cylinder 10 extends through the piston end of the piston assembly and is sealingly and slidably connected thereto. The connection between the hollow cylinder and the piston assembly is discussed in more detail below.

Piston 16 has a radially outer surface, preferably with an exterior sealing ring 26 seated therein, or other such suitable sealing system. The piston 16 has a diameter corresponding to the diameter of the cylindrical chamber 4 and is adapted to be slidingly and sealingly mounted therein for reciprocating action therethrough. The piston also has a longitudinal bore 24 travelling therethrough. Preferably, the diameter of the longitudinal bore 24 is less than the diameter of the interior 3 of the hollow cylinder rod 14 such that the piston 16 and hollow cylinder 10 are sealingly and slidably connected, as shown in FIGS. 1 and 1a.

While the preferred embodiment is shown having the sealed and sliding connection between the piston 16 and the hollow cylinder 10, other such connections are contemplated as shown in FIGS. 1b and 1c. In FIG. 1b, piston 161 is connected to the outer circumference of hollow cylinder rod 141. Piston 161 is sealingly and slidably mounted within cylindrical chamber 4. At the piston end, hollow cylinder rod 141 has piston end portion 41 having a radially inner surface with a smaller diameter than the rest of the hollow cylinder rod 141. A sealing ring 43 seated within the piston end portion 41 ensures a proper slidable seal with the hollow cylinder 10.

In FIG. 1c, the piston assembly comprises an inner cylindrical gland ring 5 connected to the interior of hollow cylinder rod 143 and an outer cylindrical piston ring 7 connected to the exterior of hollow cylinder rod 143. Outer cylindrical piston ring 7 has a sealing ring 26 ensuring a proper slidable seal between piston ring 7 and tubular body 2. Inner cylindrical gland ring 5 has a sealing ring 431 to ensure it is sealingly and slidably connected to hollow cylinder 10.

Referring again to FIG. 1, the interiors of the hollow cylinder 10 and the hollow cylinder rod 14 combine to form an interior chamber 32 that is filled with pressurized gas, preferably nitrogen. The length of hollow cylinder 10 is such that the seal between it and the piston assembly is never broken during extension and retraction of the cylinder rod thereby maintaining integrity of chamber 32.

Interior chamber 32 is filled with pressurized gas from an external source (not shown) through charge valve 50. The pressurized gas produces a bias force against hollow cylinder rod 14. The gas pressure is set at a level to compensate for the tare weight of the apparatus to be lifted by the hydraulic cylinder 1. The interior chamber 32 maximizes the volume of pressurized gas, without adding to the overall dimensions of the hydraulic cylinder 1. In addition, because the volume of interior chamber 32 can at most only be reduced to a minimum equal to the volume of the interior of the hollow cylinder 10, variations in pressure resulting from movement of the hollow cylinder rod relative to the hollow cylinder 10 are minimized.

Changes in temperature of the pressurized gas will also have an effect on the pressure within the interior chamber 32. For safety purposes, charge valve 50 is preferably adapted to act as a relief valve should the pressure of the interior chamber 32 reach a pre-set maximum.

The piston 16 sealingly mounted about hollow cylinder 10 separates cylindrical chamber 4 into a rod end (first) chamber 28 and a blind end (second) chamber 30. Rod end cylinder head 8 and blind end 6 have hydraulic fluid supply ports 36 and 38 for selectively feeding and releasing hydraulic fluid into cylindrical chambers 28 and 30, respectively. The seal between the piston 16 and the tubular body 2 is such that hydraulic fluid in rod end chamber 28 and blind end chamber 30 remains separated. The hydraulic fluid travels to and from fluid supply ports 36 and 38 through conduits 40 and 42 connected to a source of pressurized hydraulic fluid (not shown).

By selectively injecting hydraulic fluid through supply port 38 into chamber 30, while at the same time venting hydraulic fluid from chamber 28 through supply port 36, the piston and rod will be forced away from the blind end 6. Retraction of cylinder rod 14 is accomplished by injecting hydraulic fluid through supply port 36 into chamber 28, while venting the hydraulic fluid from chamber 30 through supply port 38. By selectively blocking the supply ports 36 and 38, the hollow cylinder rod 14 and piston 16 will be locked in position and maintain equilibrium.

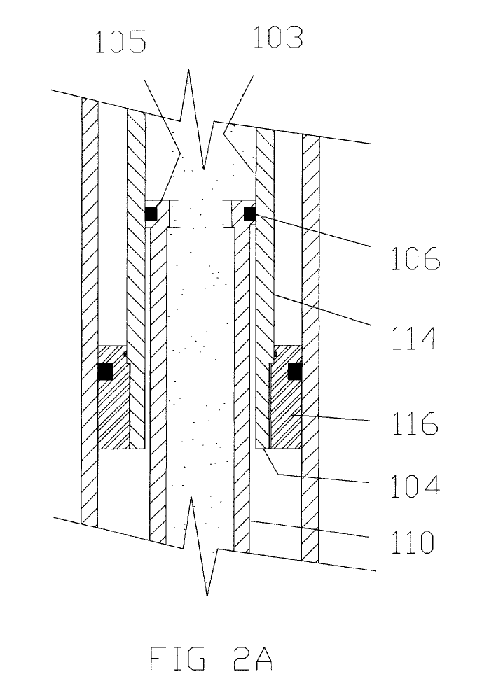

An alternative embodiment of a hydraulic cylinder 102 according to the invention is shown in FIGS. 2 and 2a. Identical reference numbers have been used to refer to identical components to the preferred embodiment.

The difference between the hydraulic cylinder 102 and hydraulic cylinder 1 shown in FIG. 1 is with respect to the seal between the piston assembly and hollow cylinder. Hydraulic cylinder 102 has a piston 116 connected to the hollow cylinder rod 114 at piston end 104. Piston 116 is in the form of a cylindrical ring fitted about the exterior of cylinder rod 114. The open end 112 of the hollow cylinder 110 extending from blind end 6 has a radially enlarged portion 105 having a sealing ring 106 which ensures a slidable seal between the hollow cylinder 110 and the interior surface 103 of hollow cylinder rod 114. The seal between the hollow cylinder 110 (by way of sealing ring 106) and the hollow cylinder rod 114 is best shown in FIG. 2a.

It is also contemplated that further sealing arrangements would be satisfactory, provided simply that the piston assembly and hollow cylinder are sealingly and slidably connected to form an interior chamber 32.

A further alternative embodiment of a hydraulic cylinder 201 having an expansion tank 34 filled with pressurized gas is shown in FIG. 3. Again, identical reference numbers have been used to refer to identical components of the various embodiments. Interior chamber 32 is fluidly connected by way of a gas supply port 31 and a conduit 33 to expansion tank 34. Interior chamber 32 and expansion tank 34 are filled with pressurized gas from a source of pressurized gas (not shown) through charge valve 50, the charge valve preferably acting as a relief valve.

The addition of the expansion tank 34 results in an increase in the volume of pressurized gas and a decrease in the percentage variation in the volume of pressurized gas when the piston is retracted (and the available volume of interior chamber 32 is decreased). The addition of an expansion tank does little to increase the overall complexity of the hydraulic cylinder, as there are no moving or service parts associated with the expansion tank, nor are any sequencing valves required.

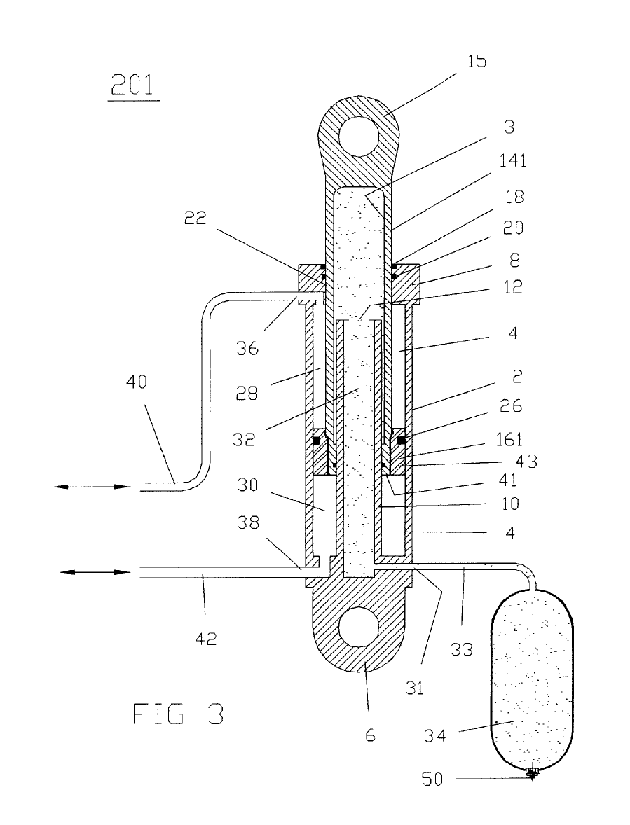

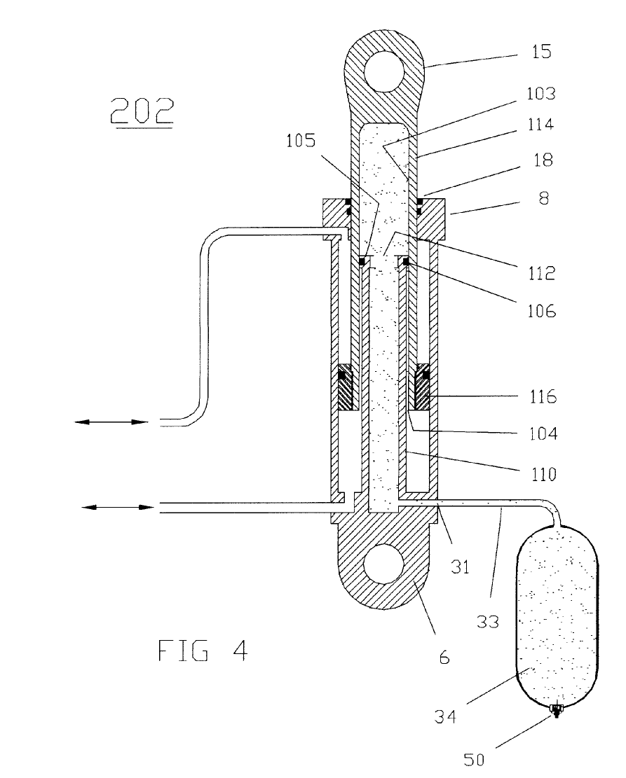

It is also contemplated that hydraulic cylinder 201 could have the piston/hollow cylinder seal discussed above in relation to hydraulic cylinder 102. This is shown in FIG. 4, where a further alternative embodiment of a hydraulic cylinder 202 is illustrated. Hydraulic cylinder 202 has an expansion tank 34 fluidly connected to interior chamber 32 via gas supply port 31 and conduit 33.

The hydraulic cylinders of the invention are designed to be used in machines for lifting and moving a payload (“material handling apparatus”). The cylinders are connected to the portions of the machine designed to lift/move the payload, these portions of the machine for the purposes of this application hereafter each being referred to as the “lifting assembly”. The gas-biasing of the hydraulic cylinder of the invention compensates for the tare weight of the lifting assembly of the machine being moved by the cylinder. By compensating for the tare weight, the gas-biased hydraulic cylinder eliminates a large percentage of the energy normally required to continually lift and manipulate the lifting assembly, such that more of the hydraulic lifting energy may be dedicated to handling the payload and resulting in an increase in productivity with the available lifting energy. Use of hydraulic cylinder in heavy machinery is shown in FIGS. 5-8.

In FIG. 5, a pair of hydraulic cylinders 1 are shown in use on a hydraulic excavator or material handler 60. A first hydraulic cylinder is shown being used to manipulate a main boom 62 and those elements of the lifting assembly connected to it, namely a stick 64, a grapple 65, and any payload in grapple 65 (none being shown). A second hydraulic cylinder manipulates the stick 64 and the grapple 65 and any payload (none being shown).

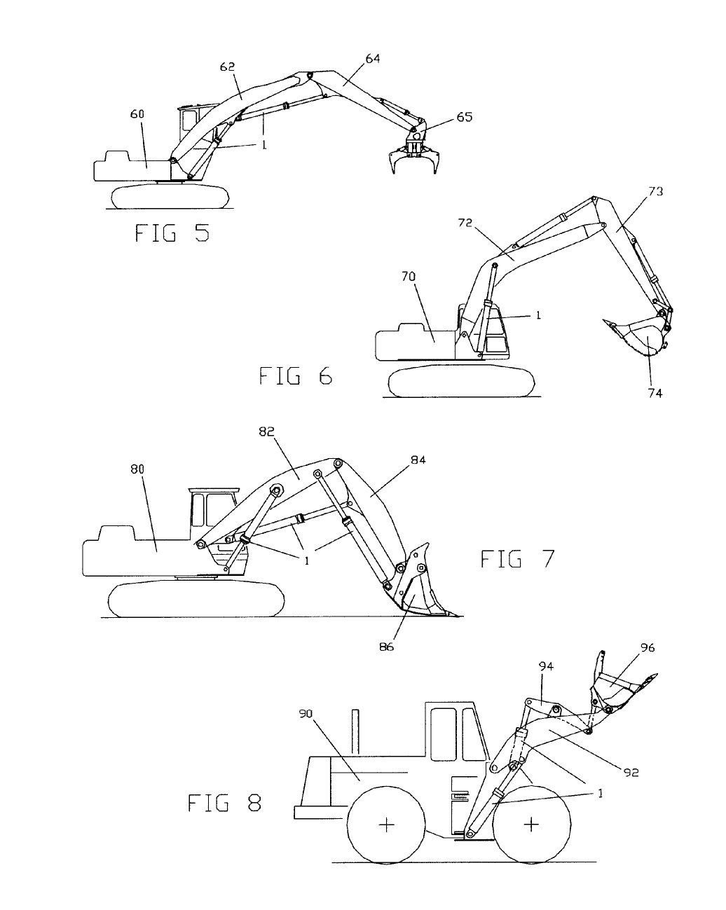

In FIG. 6, hydraulic cylinder 1 is shown being used on an excavator 70. The cylinder is shown being used to manipulate the main boom 72 along with the rest of the lifting assembly (stick 73 and bucket 74 and any payload (none being shown)). The other cylinders shown must lift the lifting assemblies to which they are attached during the retraction phase, so there is no advantage gained through the use of the present invention.

In FIG. 7, a trio of hydraulic cylinders is shown in use on a hydraulic front shovel 80. A first hydraulic cylinder is being used to manipulate main boom 82, stick 84 and bucket 86 and any payload (none being shown). A second hydraulic cylinder is being used to manipulate the stick 84 and bucket 86 and any payload. A third hydraulic cylinder is being used to manipulate the bucket 86 and any payload. The cylinders will also help in increasing the crowd forces needed to load the bucket with the least amount of energy input.

Finally, in FIG. 8, a pair of hydraulic cylinders is shown in use on a wheel loader 90. A first cylinder is shown being used to manipulate the main boom 92, bucket linkage 94, bucket 96 and any pay load (none being shown). A second cylinder is shown manipulating the bucket linkage 94, bucket 96 and any payload (none being shown).

As mentioned above, the gas pressure is set at a level to compensate for the tare weight of the lifting assembly to be actuated by the hydraulic cylinder 1. Because most heavy loading machines do not “work” in the full envelope of their range of motion, changes in the gas pressure will have a minimal impact on the operation of the cylinder. For example, excavators need the ability to reach and lift at the extremes, but that is not where they do most of their work. Preferably, the bias is set to provide the maximum benefit within the “most used envelope”. In addition, as cylinders and linkages work together, moment arms change. Linkages can be designed to counteract the effect of gas pressure changes.

It is also contemplated that the gas-biased hydraulic cylinder could be single acting only. In this embodiment, the gas-filled interior chamber would provide biasing to compensate for the tare weight of the object to be moved. Hydraulic fluid injected into chamber 30 would cause extension of the hollow cylinder rod, while venting of the hydraulic fluid from chamber 30 combined with gravity (or load material) would cause the hollow cylinder rod to retract until balanced by the gas-filled interior chamber.

It will be appreciated by those skilled in the art that the preferred and alternative embodiments have been described in some detail but that certain modifications may be practiced without departing from the principles of the invention.

What is claimed is:

1. A gas-biased hydraulic cylinder for compensating for the tare weight of a lifting assembly of a material handling apparatus to be actuated comprising:
a tubular body having first and second ends and defining a chamber;
a piston assembly comprising a cylinder rod having a piston at a piston end, said cylinder rod being hollow and passing through an opening located in said first end of said tubular body, said piston being sealingly and slidably mounted within said chamber, an opposite end of said cylinder rod being located outside of said tubular body;
a hollow cylinder projecting from said second end of said tubular body in said chamber and into said piston assembly through an opening disposed in said piston end, said hollow cylinder and said piston assembly being sealingly and slidably connected;
said piston selectively actuatable by hydraulic fluid for reciprocating action in said chamber to move said cylinder rod back and forth through said opening in said first end of said tubular body and along said hollow cylinder; and
wherein the interiors of said hollow cylinder and of said cylinder rod forming an interior chamber, said interior chamber filled with pressurized gas to bias said cylinder rod a pre-set amount to compensate for the tare weight of the lifting assembly of said material handling apparatus.

2. The cylinder of claim 1 further comprising a charge valve for filling said interior chamber with pressurized gas.

3. The cylinder of claim 1 further comprising an expansion tank in fluid connection with said interior chamber.

4. The cylinder of claim 3 wherein said expansion tank has a charge valve for filling said expansion tank and said interior chamber with pressurized gas.

5. The cylinder of claim 1 wherein said opening disposed in said piston end passes longitudinally through said piston.

6. The cylinder of claim 1 wherein said opening disposed in said piston end is defined by said hollow cylinder rod.

7. The cylinder of claim 5 wherein said piston comprising an outer cylindrical ring sealingly connected to said hollow cylinder rod, said outer ring being sealingly and slidably mounted within said tubular body, and said piston assembly further comprising an inner cylindrical ring sealingly connected to said hollow cylinder rod, said hollow cylinder being sealingly and slidably mounted in said inner cylindrical ring.

8. The cylinder of claim 6 wherein said hollow cylinder has a radially enlarged portion being sealingly and slidably connected to said hollow cylinder rod.

9. The cylinder of claim 6 wherein at said piston end, said hollow cylinder rod has a radially inner surface of reduced diameter sealingly and slidably connected to said hollow cylinder.

10. A gas-biased hydraulic cylinder for compensating for the tare weight of a lifting assembly to be actuated, said cylinder comprising a tubular body having an open end and a closed end, a hollow cylinder extending from said closed end within said tubular body, a hollow cylinder rod sealingly and slidably mounted in said open end having an actuation end outside of said tubular body and a piston end inside said tubular body, a piston connected to said piston end and sealingly and slidably mounted within said tubular body, said piston actuatable by hydraulic fluid for reciprocating action within said tubular body, said hollow cylinder and hollow cylinder rod matingly connected to form an interior chamber filled with pressurized gas to bias the cylinder a pre-set amount.

11. A gas-biased hydraulic cylinder for compensating for the tare weight of a lifting assembly of a material handling apparatus to be actuated comprising:
a tubular body having first and second ends defining a chamber;
a piston assembly having a hollow cylinder rod having a piston end, said hollow cylinder rod passing through an opening located in said first end of said tubular body and being sealingly and slidably mounted therein, an opposite end of said cylinder rod being located outside of said tubular body, said piston assembly actuatable by hydraulic fluid;
a hollow cylinder projecting from said second end of said tubular body in said chamber and into said piston assembly through an opening disposed in said piston end, said hollow cylinder and said piston assembly being sealingly and slidably connected; and
wherein the interiors of said hollow cylinder and of said cylinder rod forming an interior chamber, said interior chamber filled with pressurized gas to bias said cylinder rod a pre-set amount to compensate for the tare weight of the lifting assembly of said material handling apparatus.

12. The cylinder of claim 11 wherein said piston assembly further comprising a piston at said piston end.

13. The cylinder of claim 12 wherein said piston being sealingly and slidably mounted within said chamber.

14. The cylinder of claim 11 further comprising a charge valve for filling said interior chamber with pressurized gas.

15. The cylinder of claim 11 further comprising an expansion tank in fluid connection with said interior chamber, said expansion tank having a charge valve for filling said expansion tank and said interior chamber with pressurized gas.

16. The cylinder of claim 12 wherein said opening disposed in said piston end passes longitudinally through said piston.

17. The cylinder of claim 11 wherein said opening disposed in said piston end is defined by said hollow cylinder rod.

18. The cylinder of claim 11 wherein said piston assembly has inner and outer cylindrical rings, each sealingly connected to said hollow cylinder rod, said outer ring being sealingly and slidably connected to said tubular body, and said inner ring being sealingly and slidably connected to said hollow cylinder.

19. The cylinder of claim 17 wherein said hollow cylinder has a radially enlarged portion being sealingly and slidably connected to said hollow cylinder rod.

20. The cylinder of claim 17 wherein at said piston end, said hollow cylinder rod has a radially inner surface of reduced diameter sealingly and slidably connected to said hollow cylinder.
